(19) United States
(12) Patent Application Publication
(10) Pub. No.: US 2020/0086822 A1
(43) Pub. Date: Mar. 19, 2020

(54) SAFETY RESTRAINT SYSTEM AND METHOD

(71) Applicant: GM Global Technology Operations LLC, Detroit, MI (US)

(72) Inventors: Mathew L. Nassoiy, Milford, MI (US); Jennifer Benson, Lake Orion, MI (US)

(21) Appl. No.: 16/135,665

(22) Filed: Sep. 19, 2018

(51) Int. Cl. B60R 22/02; B60R 22/12

(52) U.S. Cl. CPC B60R 22/02; B60R 2022/1818; B60R 22/12

(57) ABSTRACT

The safety restraint system includes a seatbelt retractor fixedly secured to the motor vehicle, a seatbelt webbing, a D-ring fixedly secured to the motor vehicle, a latchplate slidably engaged with the seatbelt webbing, a buckle for releasably capturing the latchplate, and a magnet attached to the seatbelt webbing. The latchplate has a ferro-magnetic portion. The magnet generates a magnetic field to attract and hold the ferro-magnetic portion of the latchplate against the seatbelt webbing.

### INTRODUCTION

The present disclosure relates to safety restraint systems for motor vehicles that have devices or methods for securing the seatbelt and, more particularly, the seatbelt latchplate when the seatbelt is not in use.

Safety restraint systems for restraining occupants in a motor vehicle, generally, employ seatbelt retractors. The seatbelt retractors have a spool around which a seatbelt webbing is wound. The seatbelt webbing may be unwound from the spool by a vehicle occupant and secured around the vehicle occupant by inserting a latchplate slidably coupled to the seatbelt webbing into a seatbelt buckle. When not in use the seatbelt retractor, through the aid of a spring, retracts the seatbelt webbing into the retractor and onto the spool. Typically, the latchplate hangs on a vertical length of the seatbelt webbing between the D-ring and the anchor plate and is positioned between a vehicle trim panel and a side of a vehicle seat back or alternately against the seatback when the safety restraint system is not in use. The mass associated with the latchplate causes the latchplate to contact the trim panel and/or the side of the seat back creating a noise and vibration issue for the vehicle occupants. Conventional safety restraint systems and methods employ a loop of seatbelt fabric sewn onto the seatbelt webbing and positioned adjacent the latchplate between the latchplate and the vehicle trim panel to prevent the latchplate from contacting the trim panel.

Thus, while current seatbelt restraint systems achieve their intended purpose, there is a need for a new and improved safety restraint system and method for preventing the latchplate from contacting a component of a vehicle, such as a seat side panel or a B-pillar trim panel. The new and improved system and method should reduce or eliminate noise and vibration issues associated with the latchplate contacting the side of the seatback or the vehicle trim panel while locating the latch plate in an easily accessible location for the vehicle occupant.

### SUMMARY

According to several aspects, a safety restraint system for a motor vehicle is provided. The safety restraint system includes a seatbelt retractor fixedly secured to the motor vehicle, a seatbelt webbing, a D-ring fixedly secured to the motor vehicle, a latchplate slidably engaged with the seatbelt webbing, a buckle for releasably capturing the latchplate, and a first magnet attached to the seatbelt webbing. The seatbelt retractor has a frame rotatably supporting a spool. The seatbelt webbing is at least partially wound around the spool. The D-ring is slidably engaged with the seatbelt webbing to change a seatbelt webbing routing direction. The latchplate has a ferro-magnetic portion. The first magnet generates a magnetic field to attract and hold the ferro-magnetic portion of the latchplate against the seatbelt webbing.

In an additional aspect of the present disclosure, a second magnet is attached to the seatbelt webbing and spaced apart from the first magnet.

In another aspect of the present disclosure, a third magnet is attached to the seatbelt webbing and spaced apart from the second magnet.

According to several aspects, the latchplate includes a slot having a length and a width, wherein the length of the slot is greater than a width of the seatbelt webbing and a width of the slot is greater than a thickness of the seatbelt webbing.

In another aspect of the present disclosure, the slot includes a center slot portion, wherein the center slot portion has a length and a width, wherein the length of the center slot portion is greater than a width of the first magnet and a width of the center slot portion is greater than a combined thickness of a thickness of the seatbelt webbing and a thickness of the first magnet.

According to several aspects, a stop member is attached to the seatbelt webbing to prevent the latchplate from sliding past the stop member.

In another aspect of the present disclosure, the stop member is a woven seatbelt material sewn on the seatbelt webbing to prevent the latchplate from sliding past the woven seatbelt material.

In another aspect of the present disclosure, the woven seatbelt material forms a loop and is sewn on to the seatbelt webbing.

In another aspect of the present disclosure, the woven seatbelt material is sewn on to the seatbelt webbing at the location of the first magnet.

In another aspect of the present disclosure, the first magnet has a circular shape and is sewn onto the seatbelt webbing.

In yet another aspect of the present disclosure, a method for storing a component of a safety restraint system for a motor vehicle is provided. The method includes fixedly securing a seatbelt retractor to the motor vehicle, providing a seatbelt webbing, fixedly securing a d-ring to the motor vehicle, slidably engaging a latchplate with the seatbelt webbing, releasably capturing the latchplate with a buckle, and attaching a first magnet to the seatbelt webbing. The seatbelt retractor has a frame rotatably supporting a spool. The seatbelt webbing is at least partially wound around the spool. The D-ring slidably engages the seatbelt webbing to change a seatbelt webbing routing direction. The latchplate has a ferro-magnetic portion. The first magnet generates a magnetic field for attracting and holding the ferro-magnetic portion of the latchplate against the seatbelt webbing.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1a is a side perspective view of a vehicle seat and a safety restraint system disposed along the vehicle seat and a vehicle structure, according to an exemplary embodiment;

FIG. 1b is a front perspective view of a latchplate of the safety restraint system, according to an exemplary embodiment;

FIG. 1c is a front perspective view of a magnet attached to the seatbelt webbing of the safety restraint system, according to an exemplary embodiment;

FIG. 1d is a side perspective view of the magnet attached to the seatbelt webbing of the safety restraint system, according to an exemplary embodiment; and

FIG. 2 is a side perspective view of the latchplate engaged with the seatbelt webbing adjacent a loop stop and a magnet, according to another exemplary embodiment.

### DETAILED DESCRIPTION

The following description is merely exemplary in nature and is not intended to limit the present disclosure, application, or uses.

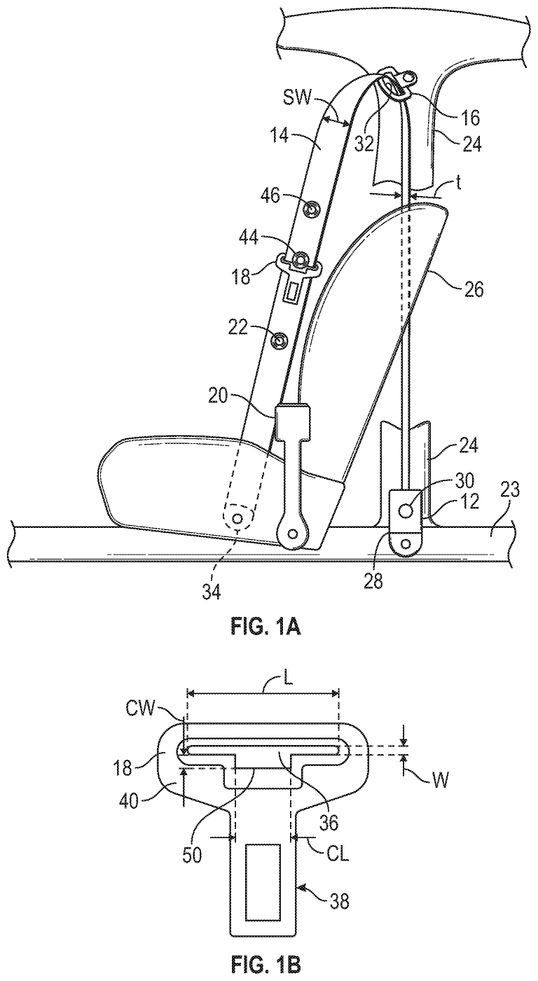

Referring to FIG. 1a, a safety restraint system 10 for a motor vehicle is illustrated, in accordance with an embodiment of the invention. Safety restraint system 10 includes a seatbelt retractor 12, a seatbelt webbing 14, a D-ring 16, a latchplate 18, a buckle 20, and a magnet 22. Seatbelt retractor 12 is fixed to a structural member 23 of the motor vehicle. For example, seatbelt retractor 12 is bolted to the base of the B-pillar 24 or other structural member of the vehicle. Alternatively, the seat belt retractor 12 may be integrated with and fixedly attached to the base of a seat 26 of the motor vehicle. A frame 28 of seatbelt retractor 12 is configured to rotatably support a spool 30 for free rotation in the retractor 12. A spring (not shown) is operatively attached to the frame 28 at one end of the spring and to the spool 30 at another end of the spring to retract the seatbelt webbing 14 onto the spool 30 and into the retractor 12. The seatbelt webbing 14 is at least partially wound around the spool 30 for storing the seatbelt webbing 14 in the retractor 12 when the safety restraint system 10 is not in use. When the safety restraint system 10 is in use the seatbelt webbing 14 is unwound from the spool 30 and pulled out of the retractor 12, typically, by a vehicle occupant. The seatbelt webbing 14 is typically made of a woven fabric material such as woven polyester.

D-ring 16 is fixedly secured to the motor vehicle, generally, towards the top of the B-pillar of the motor vehicle. A slot 32 is provided in D-ring 16 that receives and slidably engages the seatbelt webbing 14. The seatbelt webbing 14 generally extends from the retractor 12 up and along the B-pillar 24 and is threaded or routed through D-ring 16 where the seatbelt webbing 14 is directed down toward the base of the seat 26 and is secured at a terminal end 34 to a structural member of the motor vehicle or to the seat base of the seat 26.

The latchplate 18 has a slot 36 through which the seatbelt webbing 14 is threaded to slidably engage the latchplate 18 with the seatbelt webbing 14. The latchplate 18 is located on the seatbelt webbing 14, generally, between the D-ring 16 and the terminal end 34 of the seatbelt webbing 14. Latchplate 18 has a ferro-magnetic portion 38 and a non-ferro-magnetic portion 40. The buckle 20 is configured to releasably capturing the latchplate 18. Typically, latchplate 18 is pressed into a slot in buckle 20. After the latchplate 18 is fully inserted into the buckle 20 the latchplate 18 is locked in the buckle 20. A button on the buckle 20 is depressed to release the latchplate 18 from buckle 20.

As shown in FIG. 1a, magnet 22 is attached to the seatbelt webbing 14. The magnet 22 is located vertically on the seatbelt webbing 14 in a portion of the seatbelt webbing 14 between the D-ring 16 and the terminal end 34 of the seatbelt webbing 14. The magnet 22 generates a magnetic field sufficient to attract and hold the ferro-magnetic portion 38 of the latchplate 18 against the seatbelt webbing 14 at the location of magnet 22 on the seatbelt webbing 14. The present disclosure contemplates that additional magnets 44 and 46 or more may be attached at different locations on the seatbelt webbing 14. Advantageously, the additional locations for magnets 44, 46 on seatbelt webbing 14 allow the latchplate 18 to be captured and secured at these locations on seatbelt webbing 14 for easy access by the vehicle occupant.

With reference to FIGS. 1b, 1c and 1d, the latchplate 18 and magnet 22 sewn on webbing 14 are shown in greater detail, in accordance with the present disclosure. Slot 36 in latchplate 18 has a length/and a width w and has a center slot portion 50. Center slot portion 50 has a length d and a width cw. More specifically, length/of slot 36 is greater than the width sw of the seatbelt webbing 14 and width w of slot 36 is greater than a thickness t of the seatbelt webbing 14 to allow the seatbelt webbing 14 to easily slide through slot 36. Slot 36 in latchplate 18 is also configured to allow magnets 22, 44 and 46 to pass through the central slot portion 50 of slot 36. Accordingly, the length d the central slot portion 50 is greater than a width mw of the magnets and a width cw of the center slot portion 50 is greater than combined thickness of the thickness t of the webbing 14 and the thickness mt of the magnet. Thus, cw is greater than t+mt such that the magnets 22, 44 and 46 can easily slide through the center slot portion 50 of slot 36.

As shown in FIGS. 1c and 1d, magnets 22, 44 and 46 may be attached to the seatbelt webbing 14 by sewing or stitching the magnet onto the seatbelt webbing 14 using a polyester thread or other suitable thread or other attachment means. Magnets 22, 44 and 46 may be configured as a circular disk having slots or holes that may be used to receive the polyester thread to secure the magnets to the webbing 14. Permanent magnets, such as, neodymium iron boron (NdFeB), samarium cobalt (SmCo), alnico, and ceramic or ferrite magnets are all suitable magnets for use in the present invention.

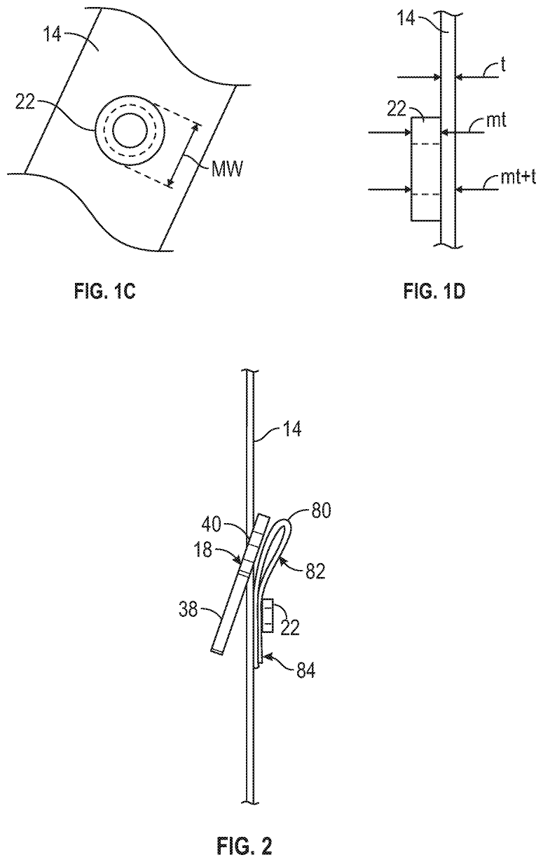

With reference now to FIG. 2, in another aspect of the disclosure a side view of the seatbelt webbing 14 and latchplate 18 is illustrated according to the present invention. In the present embodiment seatbelt webbing 14 now has a loop 80 of webbing material sewn onto the webbing 14 at a predefined location on the webbing 14. Loop 80 is located on the webbing 14 at a location the is easily accessible by a vehicle occupant. Loop 80 has a free end or flap 82 and an attached end 84. Loop 80 is sized to prevent the latchplate 18 from sliding further down the webbing 14. In other words, thickness of the free end 82 of loop 80 is larger than the width w of slot 36 in the latchplate 18 such that the latchplate 18 is not able to slide past the loop 80. The free end or flap 82 of loop 80 prevents the latchplate 18 from contacting a vehicle component such as a B-pillar or other vehicle structure. Additionally, a magnet 22 is sewn on the loop 80 at the attached end 84 of loop 80. As in the previous embodiment, the ferromagnetic portion 38 of latchplate 18 is attracted by the magnetic field of magnet 22 and held against the webbing. Advantageously, the magnet 22 and loop 80 prevent the latchplate 18 from swinging and contacting a vehicle structure or component and creating a noise and vibration issue.

The features of the safety restraint systems 10 of the present disclosure offers several advantages. These include the reduction or elimination of noise and vibration issues caused by the latchplate 18 contacting adjacent vehicle components, such as the vehicle seat 26 or structural supports such as the B, C or D-pillars. Moreover, other the aspects of the present disclosure allow the vehicle occupant to locate the latchplate 18 in a convenient location on the seatbelt webbing 14. Different occupants may have a preference where the latchplate 18 is located or stored on the seatbelt webbing 14 based on the size of the occupant or other factors.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A safety restraint system for a motor vehicle, the safety restraint system comprising:
a seatbelt retractor fixedly secured to the motor vehicle, wherein the seatbelt retractor has a frame rotatably supporting a spool;
a seatbelt webbing at least partially wound around the spool;
a d-ring fixedly secured to the motor vehicle, wherein the d-ring slidably engages the seatbelt webbing to change a seatbelt webbing routing direction;
a latchplate slidably engaged with the seatbelt webbing, wherein the latchplate has a ferro-magnetic portion;
a buckle for releasably capturing the latchplate; and
a first magnet attached to the seatbelt webbing, wherein the first magnet generates a magnetic field for attracting and holding the ferro-magnetic portion of the latchplate against the seatbelt webbing.

2. The safety restraint system of claim 1, further comprising a second magnet attached to the seatbelt webbing and spaced apart from the first magnet.

3. The safety restraint system of claim 2, further comprising a third magnet attached to the seatbelt webbing and spaced apart from the second magnet.

4. The safety restraint system of claim 1 wherein the latchplate further comprises a slot having a length and a width, wherein the length of the slot is greater than a width of the seatbelt webbing and a width of the slot is greater than a thickness of the seatbelt webbing.

5. The safety restraint system of claim 4, wherein the slot further comprises a center slot portion, wherein the center slot portion has a length and a width, wherein the length of the center slot portion is greater than a width of the first magnet and a width of the center slot portion is greater than a combined thickness of a thickness of the seatbelt webbing and a thickness of the first magnet.

6. The safety restraint system of claim 5, further comprising a stop member attached to the seatbelt webbing to prevent the latchplate from sliding past the stop member.

7. The safety restraint system of claim 1, wherein the stop member is a woven seatbelt material sewn on the seatbelt webbing to prevent the latchplate from sliding past the woven seatbelt material.

8. The safety restraint system of claim 7, wherein the woven seatbelt material forms a loop and is sewn on to the seatbelt webbing.

9. The safety restraint system of claim 8, wherein the woven seatbelt material is sewn on to the seatbelt webbing at the location of the first magnet.

10. The safety restraint system of claim 9, the first magnet has a circular shape and is sewn onto the seatbelt webbing.

11. A method for storing a component of a safety restraint system for a motor vehicle, the method comprising:
fixedly securing a seatbelt retractor to the motor vehicle, wherein the seatbelt retractor has a frame rotatably supporting a spool;
providing a seatbelt webbing at least partially wound around the spool;
fixedly securing a d-ring to the motor vehicle, wherein the d-ring slidably engages the seatbelt webbing to change a seatbelt webbing routing direction;
slidably engaging a latchplate with the seatbelt webbing, wherein the latchplate has a ferro-magnetic portion;
releasably capturing the latchplate with a buckle; and
attaching a first magnet to the seatbelt webbing, wherein the first magnet generates a magnetic field for attracting and holding the ferro-magnetic portion of the latchplate against the seatbelt webbing.

12. The method of claim 11, further comprising attaching a second magnet to the seatbelt webbing spaced apart from the first magnet.

13. The method of claim 12, further comprising attaching a third magnet to the seatbelt webbing spaced apart from the second magnet.

14. The method of claim 13, wherein slidably engaging a latchplate with the seatbelt webbing further comprises slidably engaging a latchplate having a slot, wherein the slot has a length and a width, wherein the length of the slot is greater than a width of the seatbelt webbing and a width of the slot is greater than a thickness of the seatbelt webbing.

15. The method of claim 11, wherein slidably engaging a latchplate with the seatbelt webbing further comprises slidably engaging a latchplate having a center slot portion, wherein the center slot portion has a length and a width, wherein the length of the center slot portion is greater than a width of the first magnet and a width of the center slot portion is greater than a combined thickness of a thickness of the seatbelt webbing and a thickness of the first magnet.

16. The method of claim 15, further comprising attaching a stop member to the seatbelt webbing to prevent the latchplate from sliding past the stop member.

17. The method of claim 16, wherein attaching a stop member to the seatbelt webbing further comprises attaching a woven seatbelt material by sewing the woven seatbelt material on the seatbelt webbing to prevent the latchplate from sliding past the woven seatbelt material.

18. The method of claim 11, wherein attaching a stop member to the seatbelt webbing further comprises attaching a woven seatbelt material forming a loop to the seatbelt webbing.

19. The method of claim 18, wherein attaching a stop member to the seatbelt webbing further comprises sewing a woven seatbelt material on the seatbelt webbing at the location of the first magnet.

20. The method of claim 19, wherein attaching a first magnet to the seatbelt webbing further comprises attaching a circular shaped first magnet to the seatbelt webbing.
